(19) United States
(12) Patent Application Publication
(10) Pub. No.: US 2017/0108854 A1
(43) Pub. Date: Apr. 20, 2017

(54) SCANNER WITH OVERRUN ALERT FOR PROCESS CONTROL

(71) Applicant: Honeywell International Inc., Morristown, NJ (US)

(72) Inventor: RUUD DE LIGT, VLAARDINGEN (NL)

(21) Appl. No.: 14/886,716

(22) Filed: Oct. 19, 2015

(51) Int. Cl. G05B 19/418; H04W 72/12

(52) U.S. Cl. CPC G05B 19/41855; H04W 72/12; G05B 2219/33045

(57) ABSTRACT

A method of process control includes providing in a plant a process control system including a first and at least a second field device each associated with processing equipment. The field devices are communicably coupled to ≧1 host computer by a shared field communications channel that includes a scanner which includes a data store that which supports a queue that consumes scanner bandwidth and a processor having an associated memory which implements a scanner overrun alert (SOA) algorithm stored therein. Consumption information is stored for the bandwidth (consumption information) as a scanlist in memory including primary requests for bandwidth for data from the field devices with a minimum and maximum update rate defined for each, and secondary requests for bandwidth. The SOA algorithm calculates a total percentage of the bandwidth utilized by the consumption information and generates an overrun alert when the total percentage is above 100% of the bandwidth.

### CROSS-REFERENCE TO COPENDING APPLICATIONS

This application has subject matter related to copending application Ser. No. 14/822,987 entitled “COMMUNICATIONS DEVICE WITH ADAPTIVE SCANNER FOR PROCESS CONTROL” that was filed on Aug. 11, 2015.

### FIELD

Disclosed embodiments relate to process control for industrial plants, and more particularly to communications between field devices associated with processing equipment and one or more host computers through a communications path including a shared bandwidth limited communications channel involving a scanner.

### BACKGROUND

In process control for industrial plants, there are sensors for sensing physical measurements for the process being run (e.g., pressure, temperature, level, or fluid flow) and instruments for performing monitoring and/or control output actions (e.g., control valves, actuators, drive units or tank sensors) for the processing units in the plant. These instruments are generally referred to as “field devices” or “field instruments” (hereafter “field devices”), which may be located in areas that are either manned or unmanned. These field devices are associated with the processing equipment (e.g. tanks, pipelines, boilers) which is part of the process control. For example, tank gauging systems typically involve tank sensors measuring the product inventory relevant properties (e.g., product level) within the tanks. These tank gauging systems are widely used in application areas involving handling, shipping and storing of products, as well as in the chemical process industry.

In an industrial process control system, a communications device including a transceiver, scanner and a physical memory is used for scanning the field devices at a regular interval of time to obtain measurement data such as product level, temperature, pressure, density data, which is coupled to and one or more client computers (host computers) which perform process monitoring and/or for process control. The physical memory (data store) is used to temporarily store data while it is being moved from one place to another, such as originating from the field devices to host computer(s). Host computers depend on actual, accurate and timely data acquired that originates from the field devices. The scanner handles the data acquisition from multiple field devices and passes the data on multiple hosts simultaneously. Often the same communication line (channel) and scanner is used. No matter whether the scanner acquires the data on demand, by regular polling or dynamically invokes data taking, when multiple field devices are sharing the same communication line and the same scanner, the bandwidth needs to be divided over the connected field devices.

Each host computer can have changing expectations of the scan rate (or update rate). For example, a process in a static (steady-state) stage requires less attention than a process which is in full motion (e.g., filling of a tank with product) which should generally be monitored more closely (and thus more frequently). By letting the scanner know the needed update rates the scanner can make sure every host computer is satisfied with its need to perform process control. When there is enough bandwidth provided by the scanner and the rest of the communications channel satisfying the host computers can generally be accomplished without a problem.

### SUMMARY

This Summary is provided to introduce a brief selection of disclosed concepts in a simplified form that are further described below in the Detailed Description including the drawings provided. This Summary is not intended to limit the claimed subject matter's scope.

Disclosed embodiments recognize overrun problems at the scanner which communicably couples field devices to a server module including host computer(s) can arise during process control for industrial plants (plants) when using a conventional shared communications channel for at least a portion of the communications link. Scanner overrun is recognized to occur when the scanner has insufficient channel bandwidth for handling received field device requests within the configured update limits. As a result, it is recognized the scanner's available bandwidth needs to be managed over the field device queue. A well-managed scanner in a process control system should process the queue and also leave some bandwidth room remaining for receiving service/maintenance invokes without causing the queued scanner to overrun.

For example, for conventional scanners acquiring tank gauging data from storage tanks, the bandwidth is typically limited to 2,400 baud (symbols per second or pulses per second), but often only 1,200 baud can be selected. Moreover, the need for process control information is growing creating the need of acquiring extra data such as for dynamic situations such as when tanks are being filled, preventive maintenance and redundancy. To help make sure all requests are acquired by the control system's host computer(s) at their requested update rate, it is recognized new bandwidth management is needed because scanner overrun errors can result when too many requests are put in the queue. Scanner overrun errors can lead to process control problems including customer' safety issues.

Disclosed embodiments include a new scan mechanism and an accompanying tool for managing the queues including a scanner overrun alert (SOA) algorithm generating alerts for scanner overruns. The tool allows service engineers to divide the scanner bandwidth over the various consumers (e.g., field devices) as well as provide alerts in the case of calculated queue overruns, and optionally automatically take corrective action(s) to eliminate the scanner overrun. Overruns can also be visualized graphically. In contrast, conventionally bandwidth consumption by field devices such as level gauges go unmonitored and as a result can at times cumulatively add up to ≧a theoretical bandwidth limit for the scanner, where resulting scanner problems (delays or loss of field device information) can only get resolved after an error occurs.

Disclosed embodiments include a method of process control including providing in a plant a process control system including a plurality of field devices having a first and at least a second field device each associated with processing equipment. The field devices are communicably coupled to ≧1 host computer by a shared field communications channel that includes a scanner which includes a physical memory including a data store which supports a queue that consumes scanner bandwidth. A processor having an associated memory which implements an SOA algorithm is stored therein. Bandwidth consumption information is stored for the bandwidth (consumption information) in memory including primary requests for bandwidth for data from the field devices with a specified minimum and maximum update rate defined for each, and some secondary requests for the bandwidth. The SOA algorithm calculates a total percentage of the bandwidth utilized by the consumption information and generates a scanner overrun alert when the total percentage is above 100% of the bandwidth.

### BRIEF DESCRIPTION OF THE DRAWINGS

FIG. 1 is a block diagram depiction of an example process control system (system) including a disclosed communications device comprising a disclosed scanner implementing an SOA algorithm for providing alerts of scanner overruns, according to an example embodiment.

FIG. 2 is a flow chart that shows steps in an example method of process control within an industrial plant (plant) utilizing a communications device between field devices and a host computer including a disclosed scanner and a processor implementing a disclosed SOA algorithm, according to an example embodiment.

FIGS. 3A-C are example graphical representations for disclosed scanner overrun alerts for sets of particular bandwidth consumers showing the bandwidth needed for reaching a maximum update rate and a minimum update rate, according to an example embodiment.

### DETAILED DESCRIPTION

Disclosed embodiments are described with reference to the attached figures, wherein like reference numerals are used throughout the figures to designate similar or equivalent elements. The figures are not drawn to scale and they are provided merely to illustrate certain disclosed aspects. Several disclosed aspects are described below with reference to example applications for illustration. It should be understood that numerous specific details, relationships, and methods are set forth to provide a full understanding of the disclosed embodiments.

One having ordinary skill in the relevant art, however, will readily recognize that the subject matter disclosed herein can be practiced without one or more of the specific details or with other methods. In other instances, well-known structures or operations are not shown in detail to avoid obscuring certain aspects. This Disclosure is not limited by the illustrated ordering of acts or events, as some acts may occur in different orders and/or concurrently with other acts or events. Furthermore, not all illustrated acts or events are required to implement a methodology in accordance with the embodiments disclosed herein.

Also, the terms “coupled to” or “couples with” (and the like) as used herein without further qualification are intended to describe either an indirect or direct electrical connection. Thus, if a first device “couples” to a second device, that connection can be through a direct electrical connection where there are only parasitics in the pathway, or through an indirect electrical connection via intervening items including other devices and connections. For indirect coupling, the intervening item generally does not modify the information of a signal but may adjust its current level, voltage level, and/or power level.

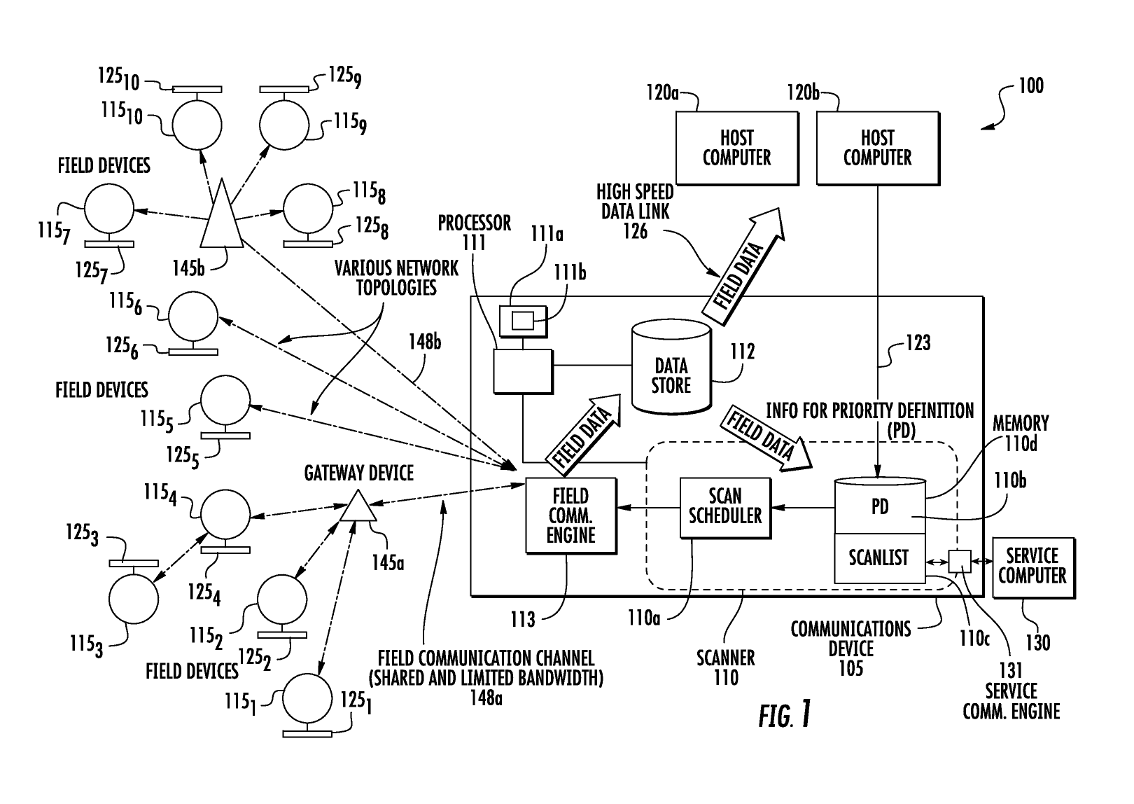

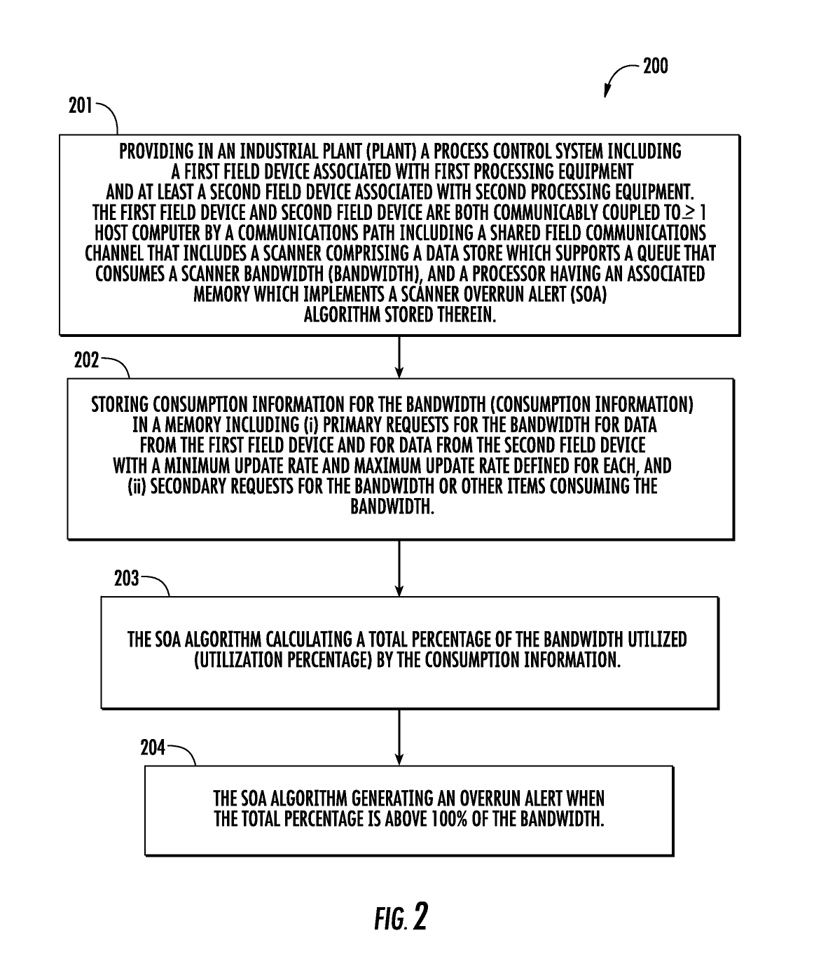

FIG. 1 is a block diagram depiction of a process control system (system) 100 including a disclosed communications device 105 comprising a scanner 110 and plurality of field devices 115₁-115₁₀ (collectively 115), where there are communications paths between the field devices 115 and communications device 105 that include optional gateway devices 145a, 145b, according to an example embodiment. Field devices 115 typically utilize serial field lines (e.g., RS-232, RS-485 or equivalent field lines) where the communications speed is slow (low baud rates). Disclosed embodiments however are not limited to serial field lines, and can also improve the overall scanning performance for Ethernet-based field communications or wireless communications as well.

Although shown at the host computers 120a and 120b (collectively host computer 120) in system 100, a disclosed scanner 110 can be positioned wherever there is limited bandwidth in a shared communication channel. Besides at the host computer 120, the scanner 110 can be positioned at the gateway devices.

All communications disclosed herein generally shown by arrows can be wireless, wired (e.g., cable), or a combination or wireless and wired. The scanner 110 is configured for individual (custom) update rates for the respective field devices 115 associated with processing equipment 125₁-125₁₀ (collectively 125) in a plant based on at least one measured parameter relevant to a data type sensed by the respective field devices 115 and/or other different considerations or data sources which can impact the update rate (or scan period). Although a single field device 115 is shown associated with each processing equipment 125, as known in the art there may be two or more field devices associated with any of the processing equipment 125 in the plant, such as level, temperature and pressure sensors on a particular piece of processing equipment (e.g., a boiler).

The scanner 110 is shown including a scan scheduler 110a and a memory 110d which stores a scanlist 110c that contains the scanning requests for the scanner 110 to perform, and also stores priority definitions (PD) 110b that is coupled to provide this priority information to the scheduler 110a. The scanner 110 assembles a queue based on the scanlist 110c in which the requests can be ranked by maximum update rate (now—last time fetched) and priority (generally ascending).

A service computer 130 is also shown in system 100 that is coupled to the scanlist 110c for invoking messages that provide data (typically priority data for each field device 115 and a minimum and maximum scan rate for each request into the scanlist 110c). The service computer 130 is used to define the scanlist 110c, the priorities and update rates, but at any time the service computer 130 can also add instant messages to the scanlist 110c. Service computer 130 generally uses a communication channel to communicate with communications device 105, such as via the communication device's service communication engine 131 shown in FIG. 1. The service computer 130 is generally able to communicate over a number of different physical layers (e.g., Ethernet, RS-485, RS232 and Wireless).

The scheduled field requests are sent to the field devices 115 over the field communications lines including shared field communications channel portion (shared communications channel) 148a, 148b using field communications engine block (field communications engine) 113. The host computers 120a, 120b provide information for the priority definition (PD) 123, such as direct field communication requests and operational commands (e.g., to set/increase priority on particular field data because of operational reasons, such as a tank level reaching a batch end) to the PD 110b from which the scan scheduler 110a determines a scan schedule (or queue). The scheduling data for the scan scheduler 110a can be implemented by the processor 111 running a disclosed SOA algorithm 111b stored in associated memory 111a (which can be an on-chip/embedded memory). The determined scan schedule stored in the scan scheduler 110a is provided to the field communications engine 113 which sequentially “requests” field data from the respective field devices 115 that is transmitted over a communications path including limited bandwidth shared communications channels 148a, 148b shown between shared communications gateway devices (gateway devices) 145a and 145b and the communications device 105.

Field devices 115₁-115₄ are shown communicably coupled to the communications device 105 through gateway device 145a while field devices 115₇-115₁₀ are shown communicably coupled to the communications device 105 through gateway device 145b. As defined herein a gateway device 145a, 145b is a device that functions as a bridge between different communication media (for example between wireless and Ethernet) that enables multiple factory floor process controllers and devices to be connected to automation controllers, eliminating the need to program message instructions between controllers or other devices. Gateway device supports a plurality of different protocols for connectivity to hundreds or thousands of field devices 115 in the plant.

Gateway devices generally comprise functional blocks including communications interfaces suitable for the medium it communicates over, such as Ethernet, wireless, HART, serial or any proprietary communications link. This is for communications on both sides of the gateway device including basic electrical conversion, optionally a data buffer particularly when there are large differences in communication speed, one or more communication interfaces which are designed specifically to match the interfaces needs, and one or more scanners (dumb, or more or less intelligent), which collect data (i.e., the scanning functionality can be distributed or delegated to the gateways such as to scan sensors connected to a tank level gauge via a local bus on or near the tank) The communications device 105 also includes a physical data store 112 which stores real-time obtained field data originating from the field devices 115 obtained via the field communications engine 113.

Field data from the data store 112 is provided to the host computers 120 over the high speed data link 126 shown which can be Ethernet or a serial link with a higher baud rate as compared to the shared communications channels 148a, 148b. Multiple host computers 120a and 120b provide a redundant host arrangement, so that each of these computers can run the same disclosed software and be ready to take over the scanning function of the primary host when this host computer fails. The scanner 110 initializes based on the information stored in a configuration database in the data store 112.

The scan scheduler 110a maintains a scanning queue based on the priorities, minimum update rates, max update rates, and by data store 112 provided most recent timestamp of previous scans of the field data items, from the field devices 115 need to be scanned. The scan scheduler 110a populates the initial queue based on the configuration.

Different requests handled by scanner 110 between field devices 115 and one or more host computers 120 in the system 100 are ranked by priority and for each a minimum and maximum update rate is defined. The SOA algorithm 111b uses this data and other commission settings of the service tool, entered by the service engineer (other individual) through service computer 130. Example settings which define algorithm input parameters that can influence the scanner's 110 bandwidth needs include: The number of fore- and background items (e.g. level in fore- and temperature in the background) to collect.
The number of fore- and background items for redundant field devices (e.g., gauges). How many field devices 115 need to be put in high priority scan when enabled.
Whether the scanner 110 should allow service tool activities, such as configuration messages or any other instruction that needs to be sent to the communications device 105.
The total bandwidth available.
The bandwidth amount which gets consumed by turn around delays.
Defined scan rates for the field devices 115.
The priority of each bandwidth consumer (e.g., field devices 115).

Based on a plurality of input parameters such as described above, the scanner 110 automatically and dynamically sets the scanning queue and identifies overruns when present.

Although the scanner 110 is shown in FIG. 1 as a localized scanner, the scanner 110 can be also be configured as a distributed scanner. In the case of a distributed scanner, the scanner can be extended to be positioned in a plurality of gateway devices as well as in the communications devices 105 as shown in FIG. 1. The scanners 110 in the respective gateway devices can generally work independently or collaboratively based on the actual scenario.

FIG. 2 is a flow chart that shows steps in an example method 200 of process control within an industrial plant (plant) utilizing a communications device between field devices and a host computer including a scanner 110 and a processor 111 implementing a disclosed SOA algorithm for providing scanner overrun alerts, according to an example embodiment. Step 201 comprises providing in the plant a process control system including a first field device associated with first processing equipment and at least a second field device associated with second processing equipment. The first field device and second field device are both communicably coupled to at least one host computer by a communications path including a shared field communications channel that includes an scanner which includes a queue that consumes scanner bandwidth (bandwidth), and a processor 111 having an associated memory 111a which implements a SOA algorithm 111b stored in the associated memory. The first field device and second field device can comprise gauges installed for sensing primary values, such as level gauges for sensing a level of a product in respective storage tanks.

Step 202 comprises storing consumption information for the bandwidth (consumption information) in a memory (e.g., as a scanlist 110c) including (i) primary requests for the bandwidth for data from the first field device and for data from the second field device with a minimum update rate and maximum update rate defined for each, and (ii) secondary requests for the bandwidth or other items consuming the bandwidth. Step 203 comprises the SOA algorithm calculating a total percentage of the bandwidth utilized (utilization percentage) by the consumption information.

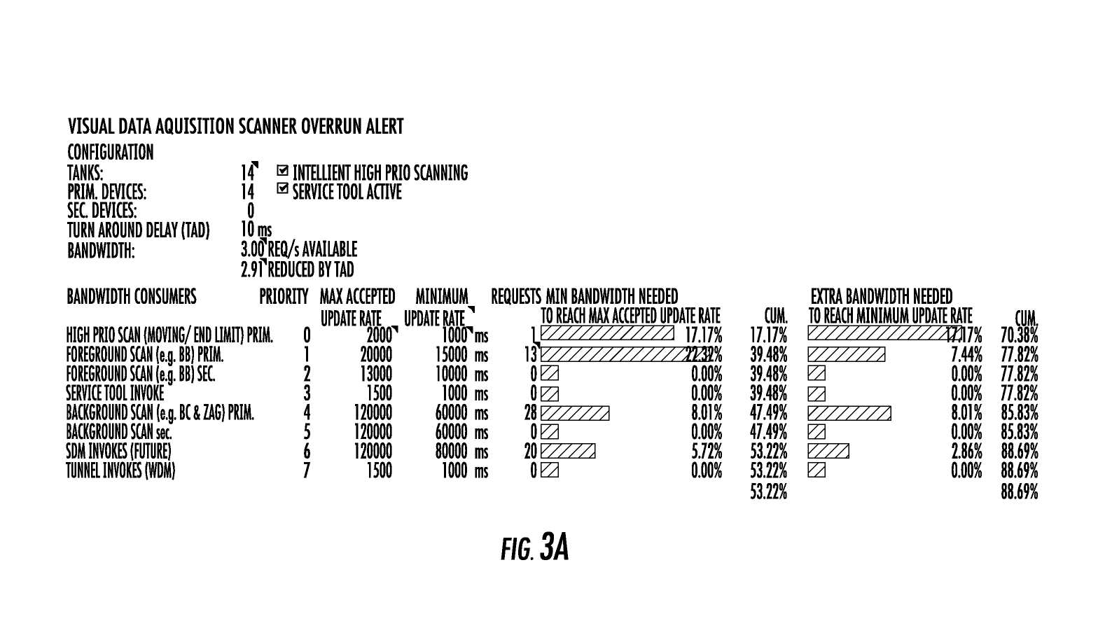

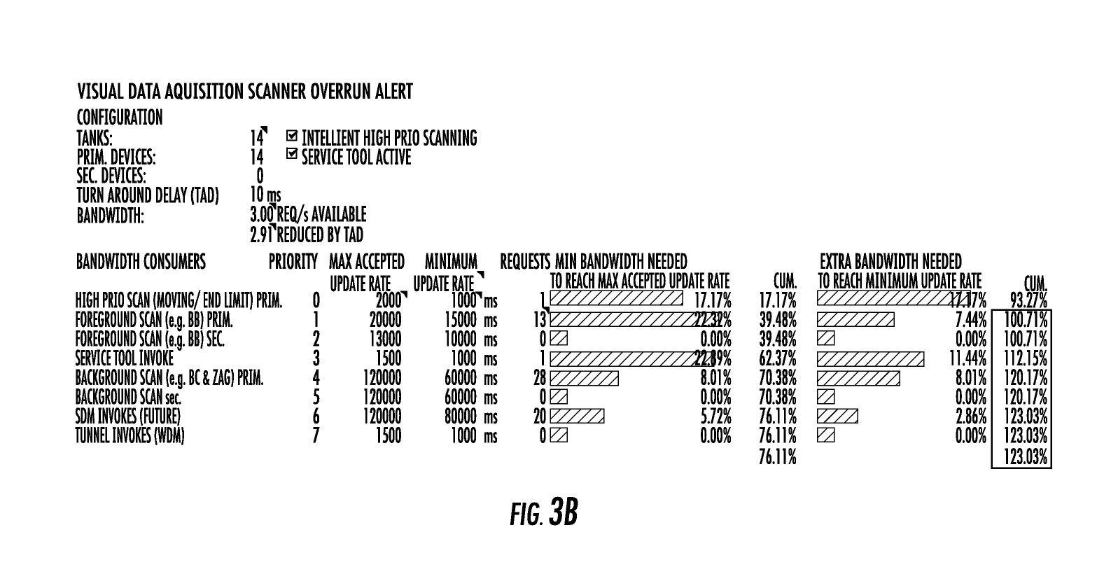

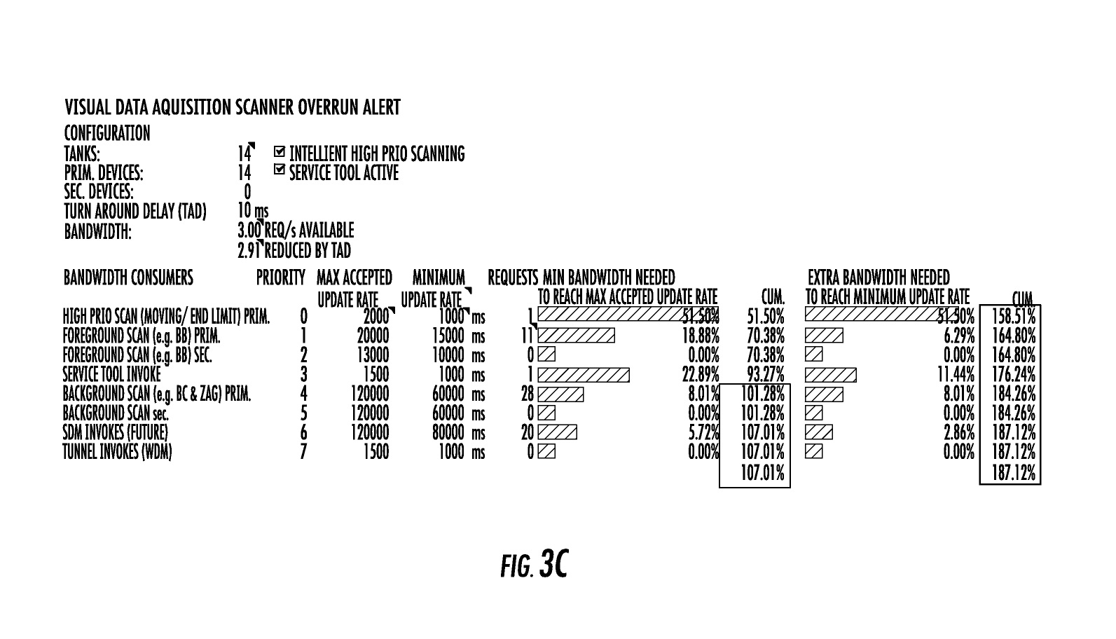

Step 204 comprises the SOA algorithm generating an overrun alert when the calculated total percentage is above 100% of the bandwidth. The alert can be either a warning or an error. In the case of a warning, the scanner wants to achieve the queue to fit in the minimum specified timing (update rate). When the queue cannot be performed within this timing, a warning, expressed by insufficient bandwidth (e.g., as a percentage) can be reported (e.g. see FIG. 3B described below which has a lack of 23.03% bandwidth). Still the scanner performs well (no overruns) by scanning all request within the maximum allowed times (update rate). In the case of an error, when more requests are added to the queue that cause the scanner's bandwidth to not be able to fulfill all the requests within the maximum defined times (update rate) an error can be reported (e.g., see FIG. 3C described below which shows there is a lack of 7.01% bandwidth).

The SOA algorithm can also compile information for displaying a graphical representation showing the bandwidth utilization percentage on a display device for the minimum update rate and for the maximum update rate, and the graphical representation can be displayed for the minimum update rate and for the maximum update rate on a display device. The method can also comprise storing a priority listing that ranks the (i) primary requests and (ii) secondary requests for the bandwidth or other items. The (ii) can comprise at least one of a) plurality of a number of fore- and background items to collect, b) a number of redundant gauges relative to the first field device and second field device, c) a total number of the first field device and second field device to be put in a high priority scan when enabled, d) whether the scanner allows service tool activities, and e) an amount of the bandwidth which gets consumed by turn-around delays.

The method can further comprise following the scanner overrun alert, the SOA algorithm recommending at least one solution (recommended solution) to the overrun. The recommended solution can include at least one of an increase in the minimum update rate or maximum update rate, disabling intelligent priority scanning, disabling external invokes, lowering a turn-around delay, and switching to a higher baud rate for the communications path (which generally needs a service engineer to implement baud rate switching). The recommended overrun solution can be automatically implemented.

Disclosed scanning can generally benefit systems where sensor data is scanned and collected over channels having a bandwidth that limits the number of requests that can be simultaneously handled. Other example applications for disclosed embodiments including for trains, cars and building automation. As long as the number of data bytes to exchange and the minimum time is specified to get the transport performed are known, disclosed SOAs can predict whether the data fits in the bandwidth or not and provide suitable alerts in the case of a calculated overrun. Application of disclosed embodiments to local lines and single master protocols (e.g., Modbus, Hart, Foundation Fieldbus, and Honeywell ENRAF GPU) is generally straightforward. Disclosed embodiments are also still applicable to TCP/IP, but generally adds some complexity since the timing is dependent of the route the messages take.

### EXAMPLES

Disclosed embodiments are further illustrated by the following specific Examples, which should not be construed as limiting the scope or content of this Disclosure in any way.

An example method of process control using a disclosed SOA algorithm operates as follows for forwarding sensed field data comprising flow or level parameter data obtained from field devices through a disclosed scanner to at least one host computer. The field devices comprise tank sensors (e.g., level gauges) in a tank gauging system including 14 tanks. In this example the scanner in the tank gauging system is assumed to be tasked to provide the following requirements:
i. Scan the primary value of a product level measurement from a level gauge (primary level gauge) for up to all 14 tanks. The update rate for these measurements is defined by the minimum update rate.
ii. Dynamically two (or more) of the level gauges will temporary switched to a (faster) update rate of 1 second.
iii. For all tanks on average two more process parameters items such as temperature and pressure will be updated in the background.
iii. Bandwidth room in the scanner's bandwidth is allocated to allow for service and maintenance messages.
iv. For tanks equipped with secondary level gauges (for redundancy), allocate bandwidth room to acquire the same level data as defined for the primary level gauges.
v. Allocate bandwidth room for site device management (SDM). SDM comprises a script running in the background to collect diagnostics data.
It is assumed at 1200 Baud 3 messages per second can be processed essentially continuously by the scanner, and at 2400 baud up to 7 messages per second can be processed essentially continuously.

### Example 1

FIG. 3A shows an example visual data acquisition scanner overrun alert in graphical form. Priority and a maximum update rate and a minimum update rate is shown for all bandwidth consumers. This example shows the data acquisition of 14 levels of which one level request is updated in 2000 ms in high priority. 28 requests are scanned in the background and each will be updated within 120 seconds. The same gets performed for the 20 SDM messages. In this view no service tool invokes are defined. To acquire the data according the maximum update rate (slowest allowed scanning) a total of 53.22% of the scanner's bandwidth is shown needed. Since there is bandwidth room the extra bandwidth is shown to be usable to meet the minimum update rate (faster scanning), which is shown in the last column to acquire the data according the minimum update rate, a total of 88.69% of the scanner's bandwidth is shown needed.

### Example 2

FIG. 3B shows an example visual data acquisition scanner overrun alert in graphical form with the same parameters as in Example 1 but with addition bandwidth consumption from the “service tool invoke” selected and thus active which requires its invoked messages to be possessed in 1 second. Although there enough bandwidth room to process all the requests at the maximum update rate as shown below, there is not enough bandwidth room to process all the requests at the minimum update rate so that a scanner overrun alert is shown visualized (such as highlighted in red) for the minimum scan rate. With this information displayed for a user, the user can adjust the minimum update rate for the scanner (such as using service computer 130 shown in FIG. 1) and thus avoid a scanner overrun.

### Example 3

FIG. 3C shows another example visual data acquisition scanner overrun alert in graphical form. When 2 more gauges dynamically switch to attention, the background messages and SDM messages will cause a scanner overrun even for the maximum update rate. The update rate of the high priority can be dropped to 2000 ms (maximum update rate) since there is no room for the extra bandwidth needed to support the minimum update rate.

While various disclosed embodiments have been described above, it should be understood that they have been presented by way of example only, and not limitation. Numerous changes to the subject matter disclosed herein can be made in accordance with this Disclosure without departing from the spirit or scope of this Disclosure. In addition, while a particular feature may have been disclosed with respect to only one of several implementations, such feature may be combined with one or more other features of the other implementations as may be desired and advantageous for any given or particular application.

1. A method of process control, comprising:
providing in an industrial plant (plant) a process control system including a first field device associated with first processing equipment and at least a second field device associated with second processing equipment, wherein said first field device and said second field device are both communicably coupled to at least one host computer by a communications path including a shared field communications channel that includes a scanner comprising a data store which supports a queue that consumes scanner bandwidth (bandwidth), and a processor having an associated memory which implements a scanner overrun alert (SOA) algorithm stored in said memory;
storing consumption information for said bandwidth (consumption information) in a memory as a scanlist including (i) primary requests for the bandwidth for data from said first field device and for data from said second field device with a minimum update rate and maximum update rate defined for each, and (ii) secondary requests for the bandwidth or other items consuming said bandwidth;
said SOA algorithm:
calculating a total percentage of said bandwidth utilized (utilization percentage) by said consumption information, and
generating an overrun alert when said total percentage is above 100% of said bandwidth.

2. The method of claim 1, further comprising said SOA algorithm compiling information for displaying a graphical representation showing said utilization percentage on a display device for said minimum update rate and for said maximum update rate, and said method further comprising displaying said graphical representation for said minimum update rate and for said maximum update rate on a display device.

3. The method of claim 1, further comprising storing a priority listing that ranks said (i) primary requests and said (ii) secondary requests for said bandwidth or other items.

4. The method of claim 1, wherein said first field device and said second field device both comprise gauges installed for sensing primary values.

5. The method of claim 4, wherein said gauges comprise level gauges for sensing a level of a product in respective storage tanks.

6. The method of claim 1, wherein said (ii) comprises at least one of a) plurality of a number of fore- and background items to collect, b) a number of redundant gauges relative to said first field device and said second field device, c) a total number of said first field device and said second field device to be put in a high priority scan when enabled, d) whether said scanner allows service tool activities, and e) an amount of said bandwidth which gets consumed by turn-around delays.

7. The method of claim 1, further comprising following said overrun alert, said SOA algorithm recommending at least one solution (recommended solution) to an overrun by said data store.

8. The method of claim 7, wherein said recommended solution includes at least one of an increase in said minimum update rate or said maximum update rate, disabling intelligent priority scanning, disabling external invokes, lowering a turn-around delay, and switching to a higher baud rate for said communications path.

9. The method of claim 8, further comprising automatically implementing said recommended solution.

10. The method of claim 1, wherein said first and said second processing equipment comprise storage tanks.

11. A software product, comprising:
a non-transitory data storage medium (memory) that includes program instructions for a scanner overrun alert (SOA) algorithm stored in said memory executable by a processor to enable said processor to execute a method of process control within an industrial plant (plant) comprising a process control system including a first field device associated with first processing equipment and at least a second field device associated with second processing equipment, wherein said first field device and said second field device are both communicably coupled to at least one host computer by a communications path including a shared field communications channel that includes a scanner comprising a data store which supports a queue (scan queue) that consumes a scanner bandwidth (bandwidth), and a processor which implements said SOA algorithm stored in said memory;
said method comprising:
storing consumption information for said bandwidth as a scanlist including (i) primary requests for the bandwidth for data from said first field device and for data from said second field device with a minimum update rate and maximum update rate defined for each, and (ii) secondary requests for the bandwidth or other items consuming said bandwidth;
said SOA algorithm:
calculating a total percentage of said bandwidth utilized (utilization percentage) by said consumption information, and
generating an overrun alert when said total percentage is above 100% of said bandwidth.

12. The software product of claim 11, further comprising said SOA algorithm compiling information for displaying a graphical representation showing said utilization percentage on a display device for said minimum update rate and for said maximum update rate, and said method further comprising displaying said graphical representation for said minimum update rate and for said maximum update rate on a display device.

13. The software product of claim 11, further comprising storing a priority listing that ranks said (i) primary requests and said (ii) secondary requests for said bandwidth or other items.

14. The software product of claim 11, wherein said (ii) comprises at least one of a) plurality of a number of fore- and background items to collect, b) a number of redundant gauges relative to said first field device and said second field device, c) a total number of said first field device and said second field device to be put in a high priority scan when enabled, d) whether said scanner allows service tool activities, and e) an amount of said bandwidth which gets consumed by turn-around delays.

15. The software product of claim 11, wherein said (ii) comprises at least one of a) plurality of a number of fore- and background items to collect, b) a number of redundant gauges relative to said first field device and said second field device, c) a total number of said first field device and said second field device to be put in a high priority scan when enabled, d) whether said scanner allows service tool activities, and e) an amount of said bandwidth which gets consumed by turn-around delays.

16. The software product of claim 11, further comprising following said overrun alert, said SOA algorithm recommending at least one solution (recommended solution) to an overrun by said scan queue.

17. The software product of claim 16, wherein said recommended solution includes at least one of an increase in said minimum update rate or said maximum update rate, disabling intelligent priority scanning, disabling external invokes, lowering a turn-around delay, and switching to a higher baud rate for said communications path.

18. The software product of claim 17, further comprising automatically implementing said recommended solution.
